(19) United States
(12) Patent Application Publication
(10) Pub. No.: US 2008/0151428 A1
(43) Pub. Date: Jun. 26, 2008

(54) Head suspension assembly and storage medium drive

(75) Inventors: Hiroaki Kushima, Kawasaki (JP); Toru Watanabe, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/904,415

(22) Filed: Sep. 27, 2007

(30) Foreign Application Priority Data
Dec. 26, 2006 (JP) 2006-349801

(51) Int. Cl. G11B 5/60; G11B 15/64; G11B 21/20

(52) U.S. Cl. 360/235.4

(57) ABSTRACT

A first joint member connects the surface of a support body to a first end surface of a head slider. A second joint member connects the surface of the support body to a second end surface of the head slider. The first and second end surfaces respectively stand upright from the surface of the support body at opposite ends of the head slider. The centroid of a first joint surface established between the first joint member and the first end surface is located in a range between the front surface of the head slider and the neutral plane. The neutral plane is established when the head slider is deformed to convex or concave the front surface. When temperature changes, the bending deformation of the medium-opposed surface is reduced. This results in prevention of a change in the flying height of the head slider.

### BACKGROUND OF THE INVENTION

1. Field of the Invention

The present invention relates to a head suspension assembly including a support body and a head slider having a back or supported surface received on the support body and a front or medium-opposed surface opposed to a storage medium.

2. Description of the Prior Art

A head slider is received on the surface of a flexure at the back or supported surface, as shown in FIGS. 18 and 19 of Japanese Patent Application Publication No. 2004-283911. A front or medium-opposed surface is defined on the backside of the supported surface. The head slider has the inflow and outflow end surfaces. The inflow and outflow end surfaces are designed to stand upright from the surface of the flexure and reach the medium-opposed surface. A first solder serves to connect the inflow end surface to the surface of the flexure. A second solder serves to connect the outflow end surface to the surface of the flexure. The first and second solders enables a relatively facilitated removal of the head slider from the flexure. This leads to a simplified operation for replacing the head slider.

A first joint surface is established between the first solder and the inflow end surface. A second joint surface is established between the second solder and the outflow end surface. The centroids of the first and second joint surfaces are located in a range between the neutral plane and the supported surface in a conventional head slider. In this case, the neutral plane is established when the head slider is deformed to convex or concave the medium-opposed surface.

The flexure has a thermal expansion coefficient larger than the thermal expansion coefficient of the flying head slider. For example, when the ambient temperature falls, the flexure suffers from a shrinkage amount larger than the shrinkage amount of the flying head slider. A thermal stress is induced in the head slider in response to the shrinkage of the flexure so as to act inward from the first and second joint surfaces. Since the centroids of the first and second joint surfaces are located in a range between the neutral plane and the supported surface, the bending moment due to a thermal stress is induced in the head slider. The bending moment is proportional to the distances between the neutral plane and the aforementioned centroids. The head slider thus suffers from a deformation convexing the medium-opposed surface. The crowning amount increases in the head slider. The increase of the crowning amount leads to a change in the flying height of the head slider. An electromagnetic transducer mounted on the head slider is thus prevented from a reliable reading/writing operation of data.

### SUMMARY OF THE INVENTION

It is accordingly an object of the present invention to provide a head suspension assembly and a storage medium drive, capable of significantly suppressing a change in the crowning amount of the head slider regardless of a change in the ambient temperature.

According to the present invention, there is provided a head suspension assembly comprising: a support body having a first thermal expansion coefficient; a head slider having a second thermal expansion coefficient different from the first thermal expansion coefficient, the head slider having the back surface received on the support body, the head slider having the front surface opposed to a storage medium; a first joint member connecting the surface of the support body to a first end surface of the head slider, the first end surface standing upright from the surface of the support body at one end of the head slider; and a second joint member connecting the surface of the support body to a second end surface of the head slider, the second end surface standing upright from the surface of the support body at an opposite end of the head slider, wherein the centroid of a first joint surface established between the first joint member and the first end surface is located in a range between the front surface of the head slider and the neutral plane, the neutral plane established when the head slider is deformed to convex or concave the front surface.

The head suspension assembly allows the support body having a thermal expansion coefficient different from the thermal expansion coefficient of the head slider. When the temperature changes, the support body deforms by a deformation amount larger than that of the head slider. A thermal stress is induced in the support body acting on the head slider from the first and second joint surfaces. The centroid of the first joint surface is located in a range between the neutral plane and the front surface, for example. When the centroid of the second joint surface is located within the neutral plane, no bending moment acts on the head slider from the centroid of the second joint surface. The total bending moment acting on the head slider is thus reduced as compared with the case where the centroids of both the first and second joint surfaces are located in a range between the neutral plane and the back surface. The bending deformation of the medium-opposed surface is reduced. Variation is significantly suppressed in the crowning amount of the head slider. This results in prevention of a change in the flying height of the head slider.

The centroid of a second joint surface established between the second joint member and the second end surface may be located in a range between the neutral plane and the back surface. A thermal stress is induced in the support body to act on the head slider from the centroids of both the first and second joint surfaces in the head suspension assembly. If the centroid of the first joint surface is located between the neutral plane and the front surface while the centroid of the second joint surface is located between the neutral surface and the supported surface, for example, the bending moment acting from the centroid of the first joint surface serves to induce the bending deformation in the direction opposite to the bending deformation resulting from the bending moment acting from the centroid of the second joint surface. The total bending moment is thus reduced as compared with the case where the centroids of both the first and second joint surfaces are located between the neutral plane and the back surface. The bending deformation of the medium-opposed surface is reduced. Variation is significantly suppressed in the crowning amount of the head slider. This results in prevention of a change in the flying height of the head slider.

In this case, the distance between the neutral plane and the centroid of the first joint surface is set equal to the distance between the neutral plane and the centroid of the second joint surface. The absolute value of the bending moment acting from the centroid of the first joint surface is set equal to the absolute value of the bending moment acting from the centroid of the second joint surface in the head suspension assembly. The bending moment acting from the centroid of the first joint surface serves to induce the bending deformation in the direction opposite to the bending deformation resulting from the bending moment acting from the centroid of the second joint surface. The bending moments are counterbalanced with each other at a middle of the centroid of the first joint surface and the centroid of the second joint surface. The total bending moment acting on the head slider is thus reduced as compared with the case where the centroids of both the first and second joint surfaces are located between the neutral plane and the back surface. The bending deformation of the medium-opposed surface is reduced. Variation is significantly suppressed in the crowning amount of the head slider. This results in prevention of a change in the flying height of the head slider.

The head suspension assembly may further comprise: a first electrically-conductive pad formed on the second end surface, the first electrically-conductive pad receiving the second joint member; a second electrically-conductive pad formed on the surface of the support body, the second electrically-conductive pad receiving the second joint member; and a wiring pattern formed on the surface of the support body, the wiring pattern being continuous with the second electrically-conductive pad.

The centroid of the first joint surface may be located within the neutral plane. The head suspension assembly allows a reduction in the bending deformation of the medium-opposed surface in the same manner as described above. Variation is significantly suppressed in the crowning amount of the head slider. This results in prevention of a change in the flying height of the head slider. Here, the centroid of a second joint surface established between the second joint member and the second end surface may be located in a range between the neutral plane and the back surface. Alternatively, the centroid of a second joint surface established between the second joint member and the second end surface may be located within the neutral plane. Variation is further suppressed in the crowning amount of the head slider.

The head suspension assembly may further comprise: a first electrically-conductive pad formed on the second end surface, the first electrically-conductive pad receiving the second joint member; a second electrically-conductive pad formed on the surface of the support body, the second electrically-conductive pad receiving the second joint member; and a wiring pattern formed on the surface of the support body, the wiring pattern being continuous with the second electrically-conductive pad.

The head suspension assembly may be incorporated in a storage medium drive. The storage medium drive may comprise: an enclosure; a carriage coupled to a support shaft for relative rotation in the enclosure; a support body defined in the carriage, the support body having a first thermal expansion coefficient; a head slider having a second thermal expansion coefficient different from the first thermal expansion coefficient, the head slider having a back surface received on the support body, the head slider having a front surface opposed to a storage medium; a first joint member connecting a surface of the support body to a first end surface, the first end surface standing upright from the surface of the support body at one end of the head slider; and a second joint member connecting the surface of the support body to a second end surface, the second end surface standing upright from the surface of the support body at an opposite end of the head slider. The centroid of a first joint surface established between the first joint member and the first end surface is located in a range between the front surface of the head slider and a neutral plane, the neutral plane established when the head slider is deformed to convex or concave the front surface. The storage medium drive achieves the advantages identical to those of the aforementioned head suspension assembly.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the inner structure of a hard disk drive, HDD, as an example of a storage medium drive according to the present invention;

FIG. 2 is an enlarged partial perspective view schematically illustrating a head suspension assembly according to a first embodiment of the present invention;

FIG. 3 is a perspective view schematically illustrating the head suspension assembly;

FIG. 4 is an enlarged partial side view schematically illustrating joint members designed to connect a flying head slider to a flexure;

FIG. 5 is an enlarged front view schematically illustrating the outflow end surface of the head slider;

FIG. 6 is an enlarged front view schematically illustrating the inflow end surface of the head slider;

FIG. 7 is an enlarged side view schematically illustrating a head suspension assembly according to a second embodiment of the present invention;

FIG. 8 is an enlarged side view schematically illustrating a head suspension assembly according to a third embodiment of the present invention;

FIG. 9 is a graph showing changes in a crowning amount and a flying height depending on temperature;

FIG. 10 is a schematic view illustrating a head slider incorporated in a head suspension assembly according to a comparative example;

FIG. 11 is a schematic view illustrating a head slider incorporated in a head suspension assembly according to a specific example 1;

FIG. 12 is a schematic view illustrating a head slider incorporated in a head suspension assembly according to a specific example 2; and

FIG. 13 is a schematic view illustrating a head slider incorporated in a head suspension assembly according to a specific example 3.

### DESCRIPTION OF THE PREFERRED EMBODIMENTS

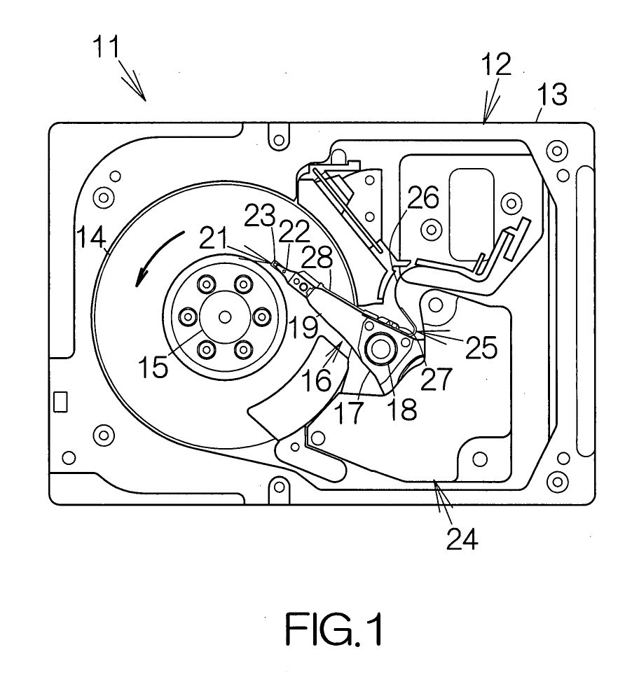

FIG. 1 schematically illustrates the inner structure of a hard disk drive, HDD, 11 as an example of a storage medium drive or a storage device according to the present invention. The hard disk drive 11 includes an enclosure 12 having a box-shaped base 13 and an enclosure cover, not shown. The base 13 defines an inner space in the form of a flat parallelepiped, for example. The base 13 may be made of a metallic material such as aluminum, for example. Molding process may be employed to form the base 13. The enclosure cover is coupled to the base 13 to close the opening of the base 13. An inner space is defined between the base 13 and the enclosure cover. Pressing process may be employed to form the enclosure cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 3,600 rpm, 4,200 rpm, 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process maybe employed to form the carriage block 17, for example.

A head suspension assembly 21 is attached to the front or tip end of the individual carriage arm 19. The head suspension assembly 21 includes a head suspension 22 extending forward from the front end of the carriage arm 19. A support body or flexure is attached to the front or tip end of the head suspension 22. The flexure will be described later in detail. A flying head slider 23 is supported on the flexure. The flexure allows the flying head slider 23 to change its attitude relative to the head suspension 22. A head element or electromagnetic transducer is mounted on the flying head slider 23.

When the magnetic recording disk 14 rotates, the flying head slider 23 is allowed to receive airflow generated along the rotating magnetic recording disk 14. The airflow serves to generate positive pressure or a lift as well as negative pressure on the flying head slider 23. The lift and the negative pressure in combination are balanced with the urging force of the head suspension 22. The flying head slider 23 is thus allowed to keep flying above the surface of the magnetic recording disk 14 during the rotation of the magnetic recording disk 14 at a higher stability.

When the carriage 16 swings around the vertical support shaft 18 during the flight of the flying head slider 23, the flying head slider 23 is allowed to move along the radial direction of the magnetic recording disk 14. The electromagnetic transducer on the flying head slider 23 is allowed to cross the data zone defined between the innermost and outermost recording tracks. The electromagnetic transducer on the flying head slider 23 can thus be positioned right above a target recording track on the magnetic recording disk 14.

A power source such as a voice coil motor, VCM, 24 is connected to the carriage block 17. The voice coil motor 24 serves to drive the carriage block 17 around the vertical support shaft 18. The rotation of the carriage block 17 allows the carriage arms 19 and the head suspensions 22 to swing.

As is apparent from FIG. 1, a flexible printed circuit board unit 25 is located on the carriage block 17. The flexible printed circuit board unit 25 includes a head IC (integrated circuit) 27 mounted on a flexible printed wiring board 26. The head IC 27 is designed to supply the read element of the electromagnetic transducer with a sensing current when the magnetic bit data is to be read. The head IC 27 is also designed to supply the write element of the electromagnetic transducer with a writing current when the magnetic bit data is to be written. A small-sized circuit board, not shown, is located within the inner space of the enclosure 12. A printed circuit board, not shown, is attached to the backside surface of the bottom plate of the base 13. The small-sized circuit board and the printed circuit board on the bottom plate are designed to supply the head IC 27 with the sensing current and the writing current. A flexible printed wiring board 28 is utilized to relay the sensing current and the writing current to the electromagnetic transducer. The flexible printed wiring board 28 is connected to the flexible printed circuit board unit 25.

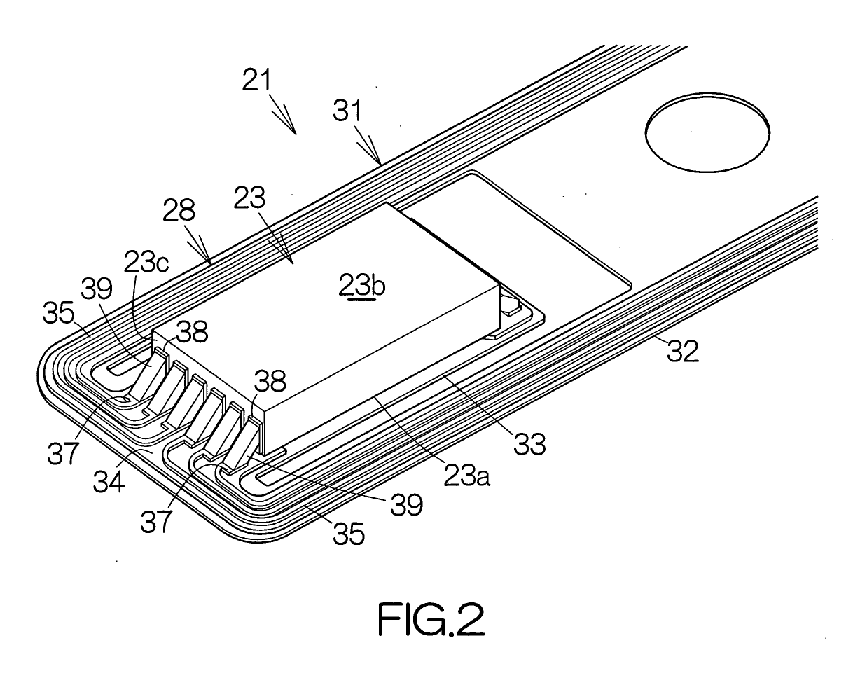

As shown in FIG. 2, the flexure 31 includes a fixation plate 32 fixed to the head suspension 22. A support plate 33 is connected to the fixation plate 32. The support plate 33 receives the flying head slider 23. The back surface or a supported surface 23a of the flying head slider 23 contacts the front surface of the support plate 33. The front surface or a medium-opposed surface 23b is defined on the backside of the supported surface 23a on the flying head slider 23. The fixation plate 32 and the support plate 33 may be made out of a single leaf spring material, for example. The leaf spring material may be made of a stainless steel plate having a constant thickness, for example. The support plate 33, namely the flying head slider 23 is allowed to change its attitude relative to the fixation plate 32.

The flexible printed wiring board 28 includes an insulating underlayer 34, for example. The insulating underlayer 34 is attached to the surfaces of the support plate 33 and the fixation plate 32. Six, for example, lines of electrically-conductive layers, namely wiring patterns 35, are formed on the surface of the insulating underlayer 34, for example. The wiring patterns 35 are designed to extend side by side, for example. The wiring patterns 35 may be made of an electrically-conductive material such as copper. The insulating underlayer 34 may be made of a resin material such as polyimide resin.

Six, for example, electrically-conductive pads 37 are formed on the surface of the insulating underlayer 34 near the outflow end of the flying head slider 23. Each electrically-conductive pad 37 is continuous with a corresponding one of the wiring patterns 35. The flying head slider 23 defines the outflow end surface 23c standing upright from the front surface of the flexure 31. Six, for example, electrically-conductive pads 38 are formed on the outflow end surface 23c. Each of the electrically-conductive pads 37, 38 receives a joint member, namely a solder 39. The solders 39 serve to connect the flying head slider 23 to the flexure 31. The electrically-conductive pads 37, 38 are made of an electrically-conductive material such as copper.

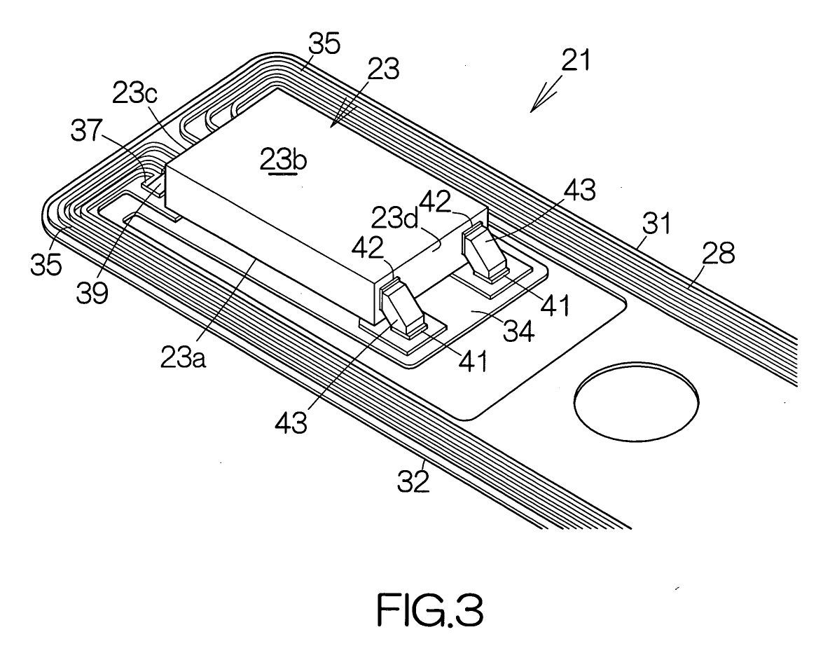

As shown in FIG. 3, two, for example, electrically conductive pads 41 are formed on the insulating underlayer 34 near the inflow end of the flying head slider 23. The flying head slider 23 defines the inflow end surface 23d standing upright from the front surface of the flexure 31. Two, for example, electrically-conductive pads 42 are formed on the inflow end surface 23d. Each of the electrically-conductive pads 41, 42 receives a joint member, namely a solder 43. The solders 43 serve to connect the flying head slider 23 to the flexure 31. The electrically-conductive pads 41, 42 are made of an electrically-conductive material such as copper.

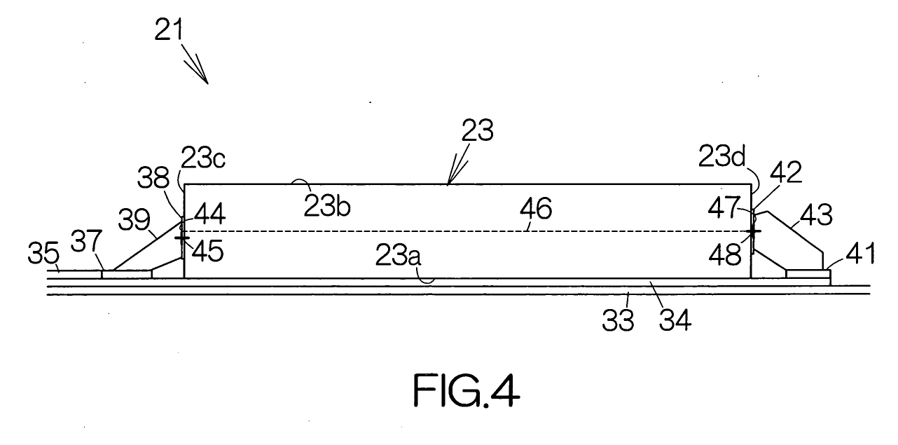

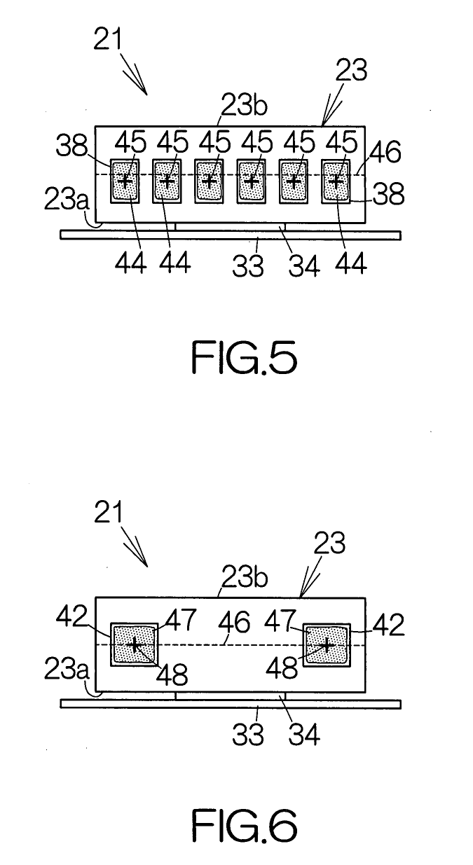

As shown in FIG. 4, a joint surface 44 is established between the solder 39 and the corresponding electrically-conductive pad 38. Referring also to FIG. 5, the centroid 45 of the individual joint surface 44 is located in a range between a neutral plane 46 and the supported surface 23a. In this case, the centroid 45 is located at a position closer to the supported surface 23a. A joint surface 47 is established between the solder 43 and the corresponding electrically-conductive pad 42. Referring also to FIG. 6, the centroid 48 of the joint surface 47 is located in a range between the neutral plane 46 and the medium-opposed surface 23b. In this case, the centroid 48 is located within the neutral plane 46 of the flying head slider 23.

The neutral plane 46 is established when the flying head slider 23 deforms to convex or concave the medium-opposed surface 23b. Adjustment of the positions of the electrically-conductive pads 38, 42 enables the adjustment of the positions of the centroids 45, 48, for example. The electrically-conductive pads 38, 42 may have wetness to the solder over the entire surfaces of the electrically-conductive pads 38, 42. The wetness allows the solders 39, 42 to spread over the entire surfaces of the electrically-conductive pads 38, 42.

The medium-opposed surface 23b is formed as a convex having a predetermined curvature in the flying head slider 23. The top of the medium-opposed surface 23b is located at the intermediate position between the outflow end surface 23c and the inflow end surface 23d, for example. The curvature is expressed in a so-called crowning amount. The crowning amount is defined as the maximum height of the medium-opposed surface 23b of the flying head slider 23 above an imaginary plane including the outflow and inflow ends of the medium-opposed surface 23b. The crowning amount is set at 20 nm approximately at normal or room temperature for the flying head slider 23, for example. The thermal expansion coefficient of the flexure 31 is set larger than the thermal expansion coefficient of the flying head slider 23.

Now, assume that temperature changes from the room temperature in the hard disk drive 11. When the temperature rises in the hard disk drive 11, for example, the flexure 31 expands by an expansion amount larger than that of the flying head slider 23. A thermal stress is induced in the flexure 31 in response to the expansion of the flexure 31 so as to act outward from the joint surfaces 44, 47. Since the centroids 48 of the joint surfaces 47 are located within the neutral surface 46, the distance is set at zero between the neutral surface 46 and the centroids 48. The bending moment acting on the flying head slider 23 from the joint surfaces 47 are thus set at zero. A predetermined distance is established between the centroids 45 of the joint surfaces 44 and the neutral plane 46. The bending moment is proportional to the distance between the neutral plane 46 and the centroids 45 of the joint surfaces 44, so that the bending moment is induced in the flying head slider 23 only from the joint surfaces 44 depending on the distance. The total bending moment acting on the flying head slider 23 is reduced as compared with the case where both the centroids 45, 48 are located in a range between the neutral plane 46 and the supported surface 23a. A reduction in the bending moment leads to a reduction in the amount of concave of the medium-opposed surface 23b. A reduction of the change in the crowning amount is thus suppressed. Variation is prevented in the flying height of the flying head slider 23. The electromagnetic transducer on the flying head slider 23 is allowed to realize a reliable read/write operation of date.

When the temperature falls in the hard disk drive 11, for example, the flexure 31 shrinks by a shrinkage amount larger than that of the flying head slider 23. A thermal stress is induced in the flexure 31 in response to the shrinkage of the flexure 31 so as to act inward from the joint surfaces 44, 47. Since the centroids 48 of the joint surfaces 47 are located within the neutral surface 46 as described above, the distance is set at zero between the neutral surface 46 and the centroids 48. The bending moment acting on the flying head slider 23 from the joint surfaces 47 is set at zero. A predetermined distance is established between the centroids 45 of the joint surfaces 44 and the neutral plane 46, so that the bending moment is induced in the flying head slider 23 only from the joint surfaces 44 depending on the distance. The total bending moment acting on the flying head slider 23 is reduced as compared with the case where both the centroids 45, 48 are located in a range between the neutral plane 46 and the supported surface 23a. A reduction in the bending moment leads to a reduction in the amount of convex of the medium-opposed surface 23b. Increase in the crowning amount is thus suppressed. Variation is prevented in the flying height of the flying head slider 23. The electromagnetic transducer on the flying head slider 23 is allowed to realize a reliable read/write operation of date.

The flying head slider 23 is prevented from a variation in the flying height in the hard disk drive 11. The stable flying height significantly contributes to improvement in the recording density. The present invention is in particular suitable to a storage medium drive employing a flying head slider enabling a perpendicular magnetic recording, a storage medium drive employing a heater for controlling the flying height of the flying head slider, or the like, for example. In general, the perpendicular magnetic recording requires a higher accuracy in the flying height of the flying head slider. The heater in the flying head slider enables control of the flying height of the flying head slider with a higher accuracy.

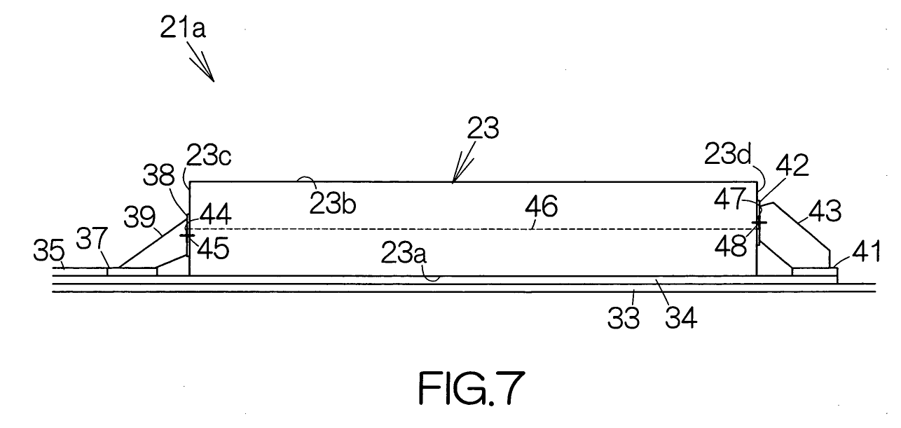

As shown in FIG. 7, ahead suspension assembly 2la according to a second embodiment may be incorporated in the hard disk drive 11 in place of the aforementioned head suspension assembly 21. The centroids 45 are located between the neutral plane 46 and the supported surface 23a in the head suspension assembly 21a. The centroids 48 are located between the neutral plane 46 and the medium-opposed surface 23b. In this case, the distance between the neutral plane 46 and the centroids 45 is set equal to the distance between the neutral plane 46 and the centroids 48. Like reference numerals are attached to the structure or components equivalent to those of the aforementioned head suspension assembly 21.

When the temperature changes, the flexure 31 expands or shrinks by an expansion amount or shrinkage amount larger than that of the flying head slider 23 in the head suspension assembly 21a in the same manner as described above. A thermal stress is induced in the flexure 31 so as to act on the flying head slider 23 from the joint surfaces 44, 47. Since the distance between the neutral plane 46 and the centroids 45 is set equal to the distance between the neutral plane 46 and the centroids 48, the absolute value of the bending moment induced in the flying head slider 23 from the centroids 45 is set equal to the absolute value of the bending moment induced in the flying head slider 23 from the centroids 48. In addition, the bending moment induced from the centroids 45 acts in the direction opposite to the direction of the bending moment induced from the centroids 48. The bending moments are counter balanced with each other at a middle of the centroids 45, 48. The total bending moment acting on the flying head slider 23 is reduced as compared with the case where both the centroids 45, 48 are set in a range between the neutral plane 46 and the supported surface 23a. The flying head slider 23 is forced to enjoy a deformation having nodes. The deformation of the medium-opposed surface 23b is reduced. The change in the crowning amount is suppressed. Variation is prevented in the flying height of the flying head slider 23. The electromagnetic transducer on the flying head slider 23 is allowed to realize a reliable read/write operation of date.

As shown in FIG. 8, the a head suspension assembly 21b according to a third embodiment may be incorporated in the hard disk drive 11 in place of the head suspension assemblies 21, 21a. The centroids 45, 48 are located within the neutral plane 46. Like reference numerals are attached to the structure or components equivalent to those of the aforementioned head suspension assembly 21.

When the temperature changes, the flexure 31 expands or shrinks by an expansion amount or shrinkage amount larger than that of the flying head slider 23 in the head suspension assembly 21b in the same manner as described above. A thermal stress is induced in the flexure 31 so as to act on the flying head slider 23 from the joint surfaces 44, 47. Since the centroids 45, 48 are located within the neutral plane 46, the distances between the neutral plane 46 and the joint surfaces 44, 47 are set at zero. The bending moment from each of the centroids 45, 48 are set at zero. The bending deformation of the medium-opposed surface 23b is thus set at zero. The change in the crowning amount is thus suppressed. Variation is prevented in the flying height of the flying head slider 23. The electromagnetic transducer on the flying head slider 23 is allowed to realize a reliable read/write operation of date.

The inventors have observed the effects of the present invention based on a simulation on a computer. The inventors prepared a comparative example and specific examples 1-3. The centroids 45, 48 were located in a range between the neutral plane 46 and the supported surface 23a in a head suspension assembly according to the comparative example. The specific example 1 corresponded to the head suspension assembly 21 according to the first embodiment. The specific example 2 corresponded to the head suspension assembly 21a according to the second embodiment. The specific example 3 corresponded to the head suspension assembly 21b according to the third embodiment. The inventors observed a change in the crowning amount and the flying height in response to a change in the ambient temperature.

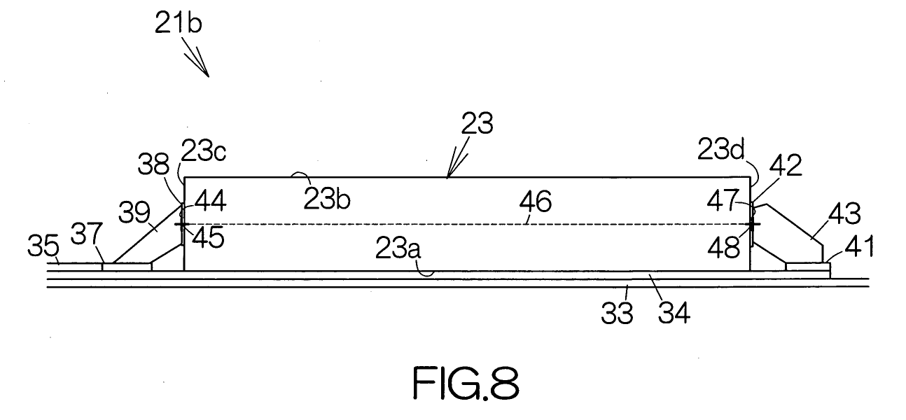

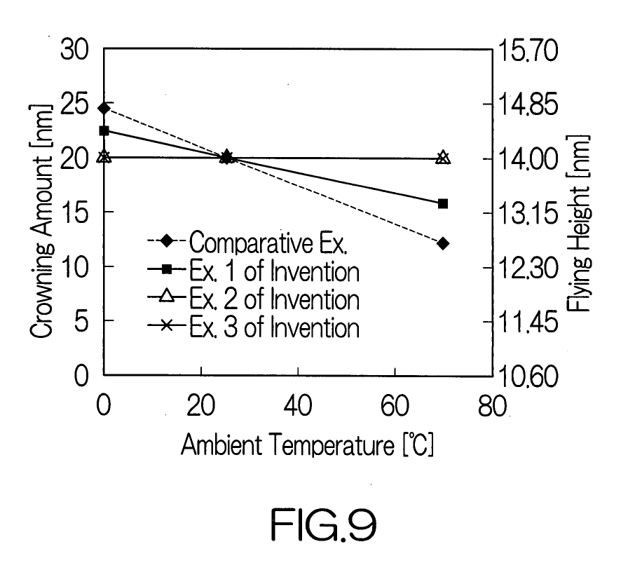

As shown in FIG. 9, the specific examples 1-3 were revealed to enjoy a suppressed a change in the crowning amount and the flying height as compared with the comparative example. FIG. 10 schematically illustrates the deformation of the flying head slider 23 according to the comparative example. Since the centroids 45, 48 are located at positions closer to the supported surface 23a in a range between the neutral plane 46 and the supported surface 23a in the comparative example, the thermal stress is induced inward from the centroids 45, 48 in response to a reduction in temperature, for example. The bending moment is induced in the flying head slider in proportion to the distances between the neutral plane 46 and the centroids 45, 48. The flying head slider 23 suffers from the medium-opposed surface convexed upward. The crowning amount is significantly increased. This results in a change in the flying height of the flying head slider.

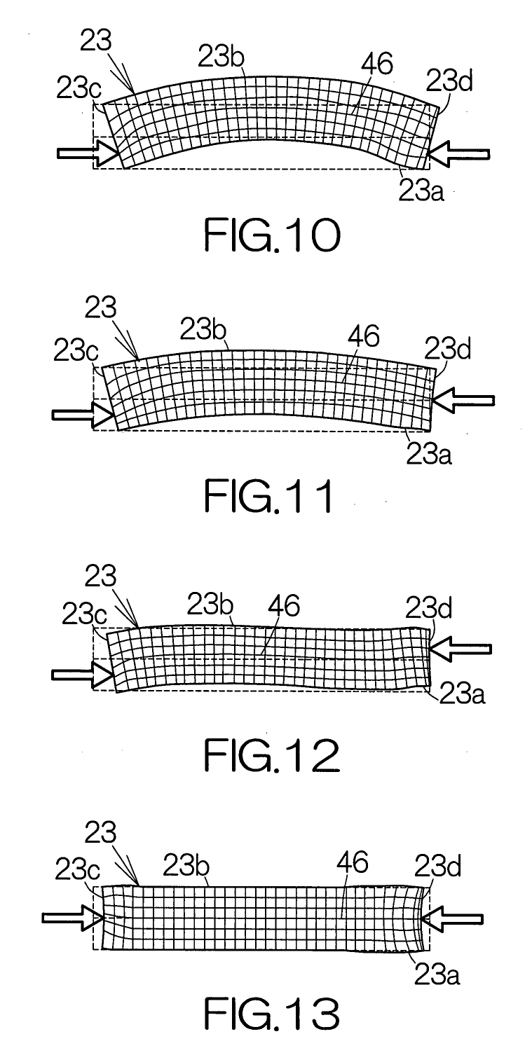

FIG. 11 schematically illustrates the deformation of the flying head slider 23 according to the specific example 1. The centroids 48 are located within the neutral plane 46 in the specific example 1. This results in a reduction in the deformation of the flying head slider 23 as compared with the flying head slider of the comparative example. Changes in the crowning amount and the flying height are significantly reduced. As shown in FIG. 12, the centroids 45 are located in a range between the neutral plane 46 and the supported surface 23a in the specific example 2. The centroids 48 are located in a range between the neutral plane 46 and the medium-opposed surface 23b. This results in a significant reduction of a change in the crowning amount and the flying height. As shown in FIG. 13, the centroids 45, 48 are located within the neutral plane 46 in the specific example 3. This results in a still significant reduction of changes in the crowning amount and the flying height.

What is claimed is:

1. A head suspension assembly comprising:
a support body having a first thermal expansion coefficient;
ahead slider having a second thermal expansion coefficient different from the first thermal expansion coefficient, the head slider having a back surface received on the support body, the head slider having a front surface opposed to a storage medium;
a first joint member connecting a surface of the support body to a first end surface of the head slider, the first end surface standing upright from the surface of the support body at one end of the head slider; and
a second joint member connecting the surface of the support body to a second end surface of the head slider, the second end surface standing upright from the surface of the support body at an opposite end of the head slider, wherein
a centroid of a first joint surface established between the first joint member and the first end surface is located in a range between the front surface of the head slider and a neutral plane, the neutral plane established when the head slider is deformed to convex or concave the front surface.

2. The head suspension assembly according to claim 1, wherein a centroid of a second joint surface established between the second joint member and the second end surface is located in a range between the neutral plane and the back surface.

3. The head suspension assembly according to claim 2, wherein a distance between the neutral plane and the centroid of the first joint surface is set equal to a distance between the neutral plane and the centroid of the second joint surface.

4. The head suspension assembly according to claim 1, wherein the centroid of the first joint surface is located within the neutral plane.

5. The head suspension assembly according to claim 4, wherein a centroid of a second joint surface established between the second joint member and the second end surface is located in a range between the neutral plane and the back surface.

6. The head suspension assembly according to claim 4, wherein a centroid of a second joint surface established between the second joint member and the second end surface is located within the neutral plane.

7. A storage medium drive comprising:
an enclosure;
a carriage coupled to a support shaft for relative rotation in the enclosure;
a support body defined in the carriage, the support body having a first thermal expansion coefficient;
ahead slider having a second thermal expansion coefficient different from the first thermal expansion coefficient, the head slider having a back surface received on the support body, the head slider having a front surface opposed to a storage medium;
a first joint member connecting a surface of the support body to a first end surface, the first end surface standing upright from the surface of the support body at one end of the head slider; and
a second joint member connecting the surface of the support body to a second end surface, the second end surface standing upright from the surface of the support body at an opposite end of the head slider, wherein
a centroid of a first joint surface established between the first joint member and the first end surface is located in a range between the front surface of the head slider and a neutral plane, the neutral plane established when the head slider is deformed to convex or concave the front surface.

8. The storage medium drive according to claim 7, wherein a centroid of a second joint surface established between the second joint member and the second end surface is located in a range between the neutral plane and the back surface.

9. The storage medium drive according to claim 8, wherein a distance between the neutral plane and the centroid of the first joint surface is set equal to a distance between the neutral plane and the centroid of the second joint surface.

10. The storage medium drive according to claim 7, wherein the centroid of the first joint surface is located within the neutral plane.

11. The storage medium drive according to claim 10, wherein the centroid of a second joint surface established between the second joint member and the second end surface is located in a range between the neutral plane and the back surface.

12. The storage medium drive according to claim 10, wherein the centroid of a second joint surface established between the second joint member and the second end surface is located within the neutral plane.
